(19) United States
(12) Patent Application Publication
(10) Pub. No.: US 2016/0239137 A1
(43) Pub. Date: Aug. 18, 2016

(54) METHOD FOR INTERACTING WITH A DYNAMIC TACTILE INTERFACE

(71) Applicant: Tactus Technology, Inc., Fremont, CA (US)

(72) Inventors: Micah B. Yairi, Fremont, CA (US); Theodore J. Stokes, Fremont, CA (US); Radhakrishnan Parthasarathy, Fremont, CA (US)

(21) Appl. No.: 15/056,127

(22) Filed: Feb. 29, 2016

Related U.S. Application Data
(63) Continuation of application No. 14/317,685, filed on Jun. 27, 2014, now abandoned.
(60) Provisional application No. 61/840,015, filed on Jun. 27, 2013.

(51) Int. Cl. G06F 3/041; G06F 3/0488; G06F 3/01

(52) U.S. Cl. CPC G06F 3/0414; G06F 3/0416; G06F 3/016; G06F 3/0488

(57) ABSTRACT

A method for registering user interaction with a dynamic tactile interface, which includes a tactile layer defining a tactile surface, a deformable region, and a peripheral region and coupled to a substrate opposite the tactile surface, the deformable region cooperating with the substrate to form a variable volume. The method includes detecting a first contact of an object at a first location on the tactile surface at a sensor; detecting a removal of the object from the first location; at a first time, detecting a first pressure of the variable volume at a pressure sensor; at the sensor, at a second time after the first time, detecting a second contact at a second location; at the second time, detecting a second pressure at the pressure sensor; interpreting the first and second contact, and the pressure difference as a gesture; and executing a command corresponding to the gesture.

### CROSS-REFERENCE TO RELATED APPLICATIONS

This application is a continuation of U.S. application Ser. No. 14/317,685, filed 27 Jun. 2014, which claims the benefit of U.S. Provisional Application No. 61/840,015, filed on 27 Jun. 2013, both of which are incorporated in their entirety by this reference.

### TECHNICAL FIELD

This invention relates generally to the field of touch-sensitive displays, and more specifically to a new and useful user method for reducing perceived optical distortion of light output through a dynamic tactile interface in the field of touch-sensitive displays.

### BRIEF DESCRIPTION OF THE FIGURES

FIG. 1 is a flowchart representation of method of one embodiment of the invention;

FIG. 2 is a flowchart representation in accordance with one variation of method S200;

FIG. 3 is a flowchart representation of a method of one embodiment of method;

FIG. 4 is a flowchart representation in accordance with one variation of method;

FIG. 5 is a schematic representation in accordance with one variation of method;

FIG. 6 is a schematic representation in accordance with one variation of method; and

FIG. 7 is a schematic representation in accordance with multiple variations of method S100 and method.

### DESCRIPTION OF THE EMBODIMENTS

The following description of the embodiments of the invention is not intended to limit the invention to these embodiments, but rather to enable any person skilled in the art to make and use this invention.

### 1. Methods and Applications

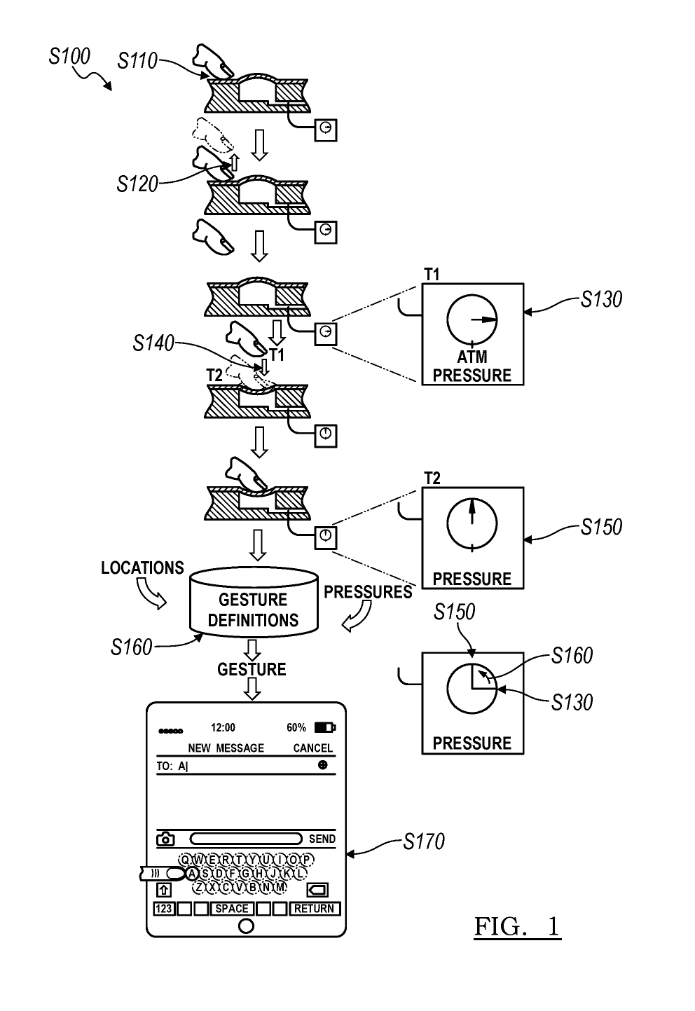

Method S100 for registering user interaction executes on a computing device incorporating a dynamic tactile interface, wherein the dynamic tactile interface includes a tactile layer and a substrate, the tactile layer defines a tactile surface, a deformable region, and a peripheral region adjacent the deformable region and coupled to the substrate opposite the tactile surface, and the deformable region cooperates with the substrate to form a variable volume filled with a mass of fluid. As shown in FIG. 1, the method S100 includes: detecting an object contacting the tactile surface at a first location on the tactile surface in Block S110; detecting a removal of the object from the first location in Block S120; measuring an initial pressure of the mass of fluid in the variable volume when there is no contact on the tactile surface in Block S130; detecting a second contact by the object on the tactile surface; detecting a second contact by the object on the tactile surface in Block S140; measuring a second pressure of the mass of fluid in the variable volume substantially at the time of the second contact in Block S150; interpreting the two contacts in response to a pressure difference as an input gesture in Block S160; and executing a command that corresponds with the input gesture in Block S170.

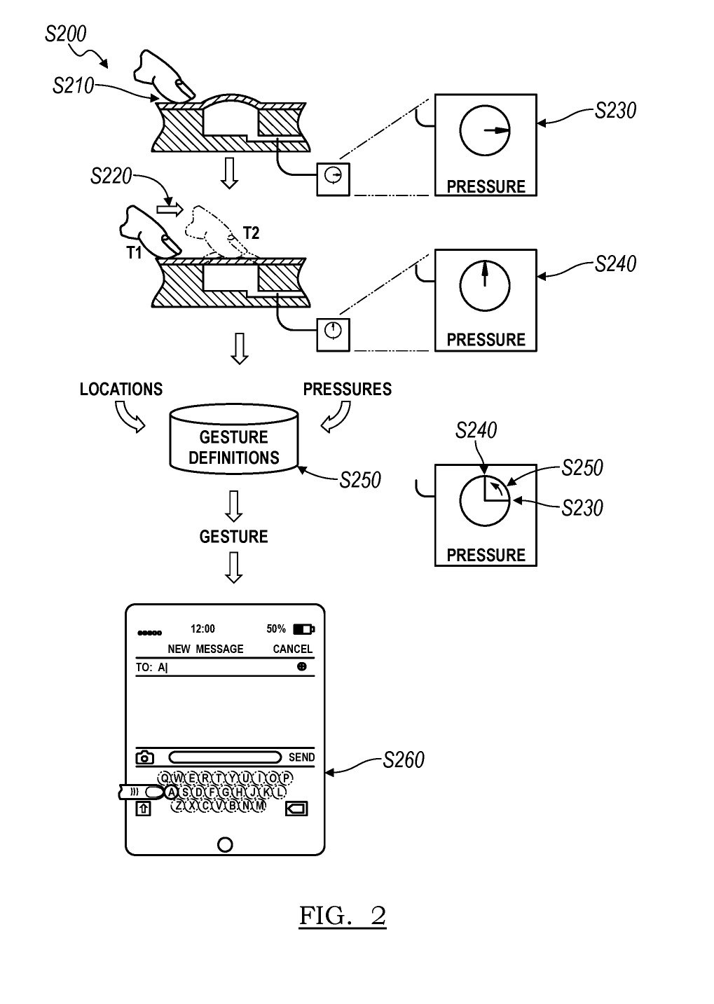

As shown in FIG. 2, similar method S200 includes: detecting an object contacting the tactile surface in S210; detecting the object moving along the tactile surface in Block S220; measuring an initial pressure of the mass of fluid in the variable volume when there is no contact with the deformable region in Block S230; measuring a second pressure of the mass of fluid in the variable volume substantially at the time when the object contacts the deformable region in Block S240; interpreting the movement of the object along the tactile surface in response to a pressure difference between the first and second pressures as an input gesture in Block S250; and executing a command that corresponds with the input gesture in Block S260.

Generally, method S100 includes registering user interaction with a dynamic tactile interface by detecting a contact on a tactile surface with a touch sensor, including the location of the contact, and detecting the magnitude of the force applied by the contact with a pressure sensor coupled to a deformable region.

In one example, methods S100 and S200 control how an object or a user interacts with a computing device incorporating a dynamic tactile interface and a display, wherein the display renders a virtual input key through a peripheral region of the tactile layer, and wherein the object contacts a deformable region adjacent the peripheral region to indicate an input gesture corresponding to the virtual key. When the deformable region is in the expanded setting, the deformable region is filled with a mass of fluid and is tactilely distinguishable (e.g., expands above the surface of the peripheral region) from the surrounding peripheral region and thus provides tactile guidance to a user interfacing with the computing device. Methods S100 and S200 can further interface with a pressure sensor to detect a first fluid pressure of a mass of fluid adjacent the deformable region (as in Block S130), to detect a second pressure of the mass of fluid (as in Block S150), and to interpret a pressure difference between the first and second pressures (as in Block S160), and methods S100 and S200 can interface with a touch sensor to set an active input area adjacent the displayed image (but not overlapping the deformable region) and to detect a contact by an object on the tactile surface at the active sensing area in (as Blocks S110, S140, S210, and S220). Thus methods S100 and S200 can discern between intentional and incidental inputs into the computing device and between different types of inputs into the computing device based on a sequence, timing, and/or magnitude of a fluid pressure difference and one or more contacts on the tactile surface proximal the deformable region and/or the displayed image of a corresponding key (as in Block S160). Methods S100 and S220 can further execute commands on the computing device based on the intentional inputs (as in Block S170).

As shown in FIG. 1, in one example implementation of method S100, a user places a finger on the tactile surface of a device with a dynamic tactile interface situated over a display. The user contacts a location on the tactile surface corresponding to an image of a key displayed on the display and through the dynamic tactile interface. Block S110 interfaces with a touch sensor within the dynamic tactile interface to detect the contact by the finger at a touch sensor coupled to the tactile surface. The user then lifts the finger off the tactile surface. Block S120 interfaces with the touch sensor to detect the removal of the finger from the tactile surface at the location of the first contact. Block S130 then detects the pressure of the variable volume at a time when Block S120 detects the removal of the finger. The user then places the finger back on the tactile surface at a location on the tactile surface corresponding to a deformable region. The finger depresses the deformable region, which thus transitions from an expanded setting that is tactilely distinguishable from the peripheral region to a retracted setting that is substantially flush with the peripheral region. Block S140 interfaces with the touch sensor to detect the contact on the deformable region. Block S150 detects a pressure of the volume of fluid within the deformable region at a time substantially corresponding to the finger depressing the deformable region. In response to a pressure difference between the first and second pressures of or greater than a certain magnitude, Block S160 interprets the first and second contacts by the finger as a gesture indicating selection of the key displayed on the display. Block S170 executes a command corresponding to the selection of the key, such as by displaying a letter in a virtual text input field for the key that represents an alphanumeric key.

Method S100 can execute on a dynamic tactile interface with a tactile layer that defines a deformable region and a peripheral region, wherein the peripheral region is adjacent the deformable region and coupled to the substrate opposite a tactile surface. The deformable region can also cooperate with the substrate to define a variable volume, and a displacement device can be coupled to the variable volume via a fluid channel defined by the substrate, wherein actuation of the displacement device can pump fluid into and out of the variable volume filled with a mass of fluid to expand and retract the deformable region, respectively.

Method S100 can include a tactile layer that also includes multiple deformable regions that can selectively transition between retracted and expanded settings in unison and/or independently. A valve between the displacement device and a fluid channel can actuate to open a path for fluid to flow from the displacement device through the fluid conduit to the transition of the deformable region. Block S130 and Block S150 detect a change in pressure within the variable volume from a first time to a second time after the first time, the change in pressure resulting from displacement of fluid to transition the deformable region. A processor in Block S160 interprets the change of pressure. In one implementation, method S100 includes a dynamic tactile interface with an array of deformable regions patterned across the digital display in a keyboard arrangement, as shown in FIG. 5. In another implementation, method S100 includes a dynamic tactile interface with a set of deformable regions that collectively define a tactile display (e.g., a tixel or pixel-level tactile display), the deformable regions can be reconfigured into tactilely distinguishable formations in combinations of positions and/or heights to imitate a form of a touch shared from another computing device. In yet another implementation, method S100 includes a dynamic tactile interface with a set of five deformable regions arranged in a spread-finger pattern over an off-screen region of the computing device, wherein the five deformable regions can be selectively raised and lowered to imitate fingertip contact shared from another computing device.

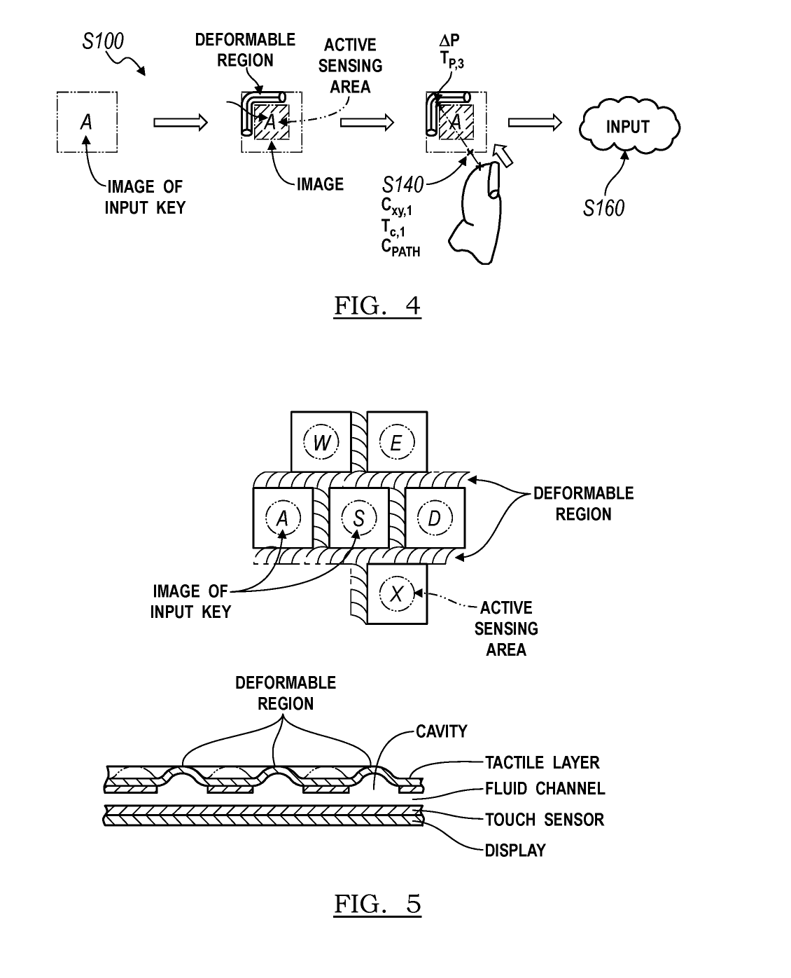

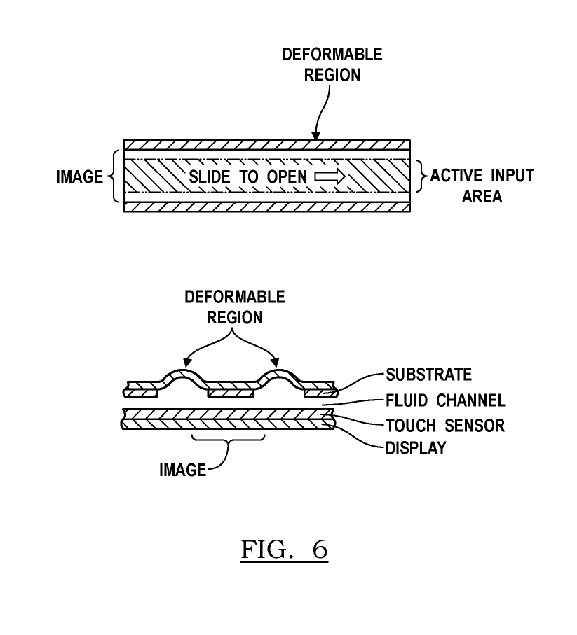

As shown in FIGS. 4 and 5, method S100 can include a deformable region that, in the expanded setting, can define a ridge (e.g., guide) adjacent the peripheral region, wherein the ridge provides tactile guidance to a user to discern the location of the peripheral region, the active sensing area, and/or the image of the input key. For example, the deformable region in the expanded setting can define a linear ridge, an arcuate ridge, a corner-shaped ridge, a cusp-shaped ridge, or a ridge of any other shape or geometry. The peripheral region can be attached to the substrate and therefore remain fixed to the substrate independent of the vertical position of the deformable region, and the substrate can include a support member that extends into the variable volume filled with a mass of fluid to support the deformable region against inward deformation substantially below the peripheral region. However, the dynamic tactile interface, the peripheral region, the deformable region, etc. can be of any other form.

### 2. Dynamic Tactile Interface

As shown in FIG. 1, method S100 defines an active input area corresponding to an input key and identifies an input based on position, motion, timing, and/or fluid pressure differences in an adjacent variable volume filled with a mass of fluid resulting from an input on a tactile surface of a dynamic tactile interface. In particular, methods S100 and S200 can be implemented in conjunction with a dynamic tactile interface as described in U.S. patent application Ser. No. 11/969,848, filed on 4 Jan. 2008, in U.S. patent application Ser. No. 12/319,334, filed on 5 Jan. 2009, in U.S. patent application Ser. No. 12/497,622, filed on 3 Jul. 2009, in U.S. patent application Ser. No. 12/652,704, filed on 5 Jan. 2010, in U.S. patent application Ser. No. 12/652,708, filed on 5 Jan. 2010, in U.S. patent application Ser. No. 12/830,426, filed on 5 Jul. 2010, in U.S. patent application Ser. No. 12/830,430, filed on 5 Jul. 2010, which are incorporated in their entireties by this reference. In particular, method S100 can be implemented on an electronic device incorporating a dynamic tactile interface, such as a smartphone, tablet computer, mobile phone, personal data assistant (PDA), personal navigation device, personal media player, calculator, camera, water, or gaming controller. Alternatively, method S100 can be implemented on an automotive console, desktop computer, laptop computer, television, radio, desk phone, light switch, lighting control box, cooking equipment, wearable device, or any other suitable computing device incorporating a dynamic tactile interface. The electronic device can also include a digital display.

Method S100 can be implemented on a computing (e.g., electronic) device that also includes a digital display coupled to a substrate opposite a tactile layer and can interface with a displacement device to displace fluid from a reservoir into a variable volume filled with a mass of fluid, thereby transitioning a deformable region, which partially defines the variable volume, into an expanded setting and raising the tactile surface at the deformable region above the tactile surface at the peripheral region such that the deformable region is tactilely distinguishable from the peripheral region. Method S100 can alternatively interface with a dynamic tactile interface in which the deformable region in the expanded setting is flush with the peripheral region or below the peripheral region. However, in the expanded setting, the deformable region can define any other formation that is capable of being deformed or depressed by an input object.

Method S100 can execute on a computing device further including a touchscreen display, and Block S110 and Block S140 can interface with the touchscreen to interpret a contact on the tactile surface by an object, such as a finger or a stylus, as an input into the computing device, and Block S170 can interface with the touchscreen to render images corresponding to inputs for a user to see. Block S110 and Block S140 of method S100 can additionally or alternatively execute on a computing device including a discrete display and a discrete touch sensor, such as an optical, capacitive, resistive, piezoelectric strain gauge, electromagnetic touch sensor, or any other touch sensor suitable for detecting a contact on the tactile surface. Block S130 and Block S150 can further interface with one or more pressure sensors coupled to the variable volume via a fluid channel within the computing device. The pressure sensor can be an absolute, gauge, vacuum, differential, sealed pressure, or any other type of pressure sensor suitable for detecting the pressure of a volume adjacent a deformable region and filled with a mass of fluid.

In Blocks S110 and S140, method S100 detects an object contacting the tactile surface, such as a finger, stylus, hand, elbow, writing utensil, lip, knuckle, or any other object suitable for inputting a command into a dynamic tactile interface. The object also can be made of any material, such as human flesh, metal, plastic, or any other suitable material. However, the object can exhibit any other material property and can be made of any suitable material.

Blocks S110 and S140 detect contacts by an object on the tactile surface of the tactile layer of the dynamic tactile interface. The tactile layer includes a tactile surface opposite an attachment surface, a peripheral region, and a deformable region. In a variation in which Blocks S110 and S140 detect an object contacting a dynamic tactile interface coupled to a digital display, the tactile layer can be substantially transparent or translucent. In a variation in which Blocks S110 and S140 detect an object contacting a dynamic tactile interface coupled to an electronic device without a digital display, the tactile layer can be opaque. The tactile layer can be attached to a substrate via an attachment face opposite the tactile surface of the tactile layer. The tactile layer includes one or more peripheral regions and one or more deformable regions. In one implementation, a deformable region is adjacent the peripheral region, wherein a portion of the peripheral region includes an active sensing area. In a variation in which the dynamic tactile interface lies over a digital display, Block S110 and S140 can detect an object contacting the active sensing area residing substantially over an image of an input key or substantially adjacent an area directly over the image of the input key. The active sensing area can be of any shape or size and can correspond to a touch sensor, such as a capacitive touch sensor, resistive touch sensor, optical touch sensor, and/or other sensor configured to detect contact at one or more points or areas on the computing device. Additionally or alternatively, Blocks S110 and S140 can detect a contact on the tactile surface with any other suitable type of sensor or input region configured to capture an input on a surface of the device. The device can also incorporate an optical sensor (e.g., a camera), a pressure sensor, a temperature sensor (e.g., a thermistor), or other suitable type of sensor to capture an image (e.g., a digital photographic image) of the input object (e.g., a stylus, a finger, a face, lips, a hand etc.), a force and/or breadth of an input, a temperature of the input, etc., respectfully.

### 3. Two Contact Gesture

Block S110 of method S100 recites detecting an object contacting the tactile surface at a first location on the tactile surface. Generally, Block S110 functions to detect a first contact by the object on the tactile layer at an active sensing area.

In one implementation, an object, such as a finger or a stylus, contacts the tactile surface, and Block S110 detects the first contact on the tactile surface at an active sensing area adjacent a deformable region and corresponding to a touch sensor. In this implementation, the first contact can touch, slide across, rest on, hover over, or otherwise contact the tactile surface, and Block S110 interfaces with a sensor (e.g., a capacitive, optical, or resistive touch sensor) within the computing device to detect the first contact as the first contact touches, slides across, rests on, hovers over, or otherwise contacts the peripheral region of the tactile surface.

Block S120 of method S100 recites detecting the removal of the object from the first location. Generally, Block S120 functions to detect removal of the object from a location of the first contact detected in Block S110. In one implementation, Block S120 detects separation (i.e., complete removal) of the object from the tactile surface. In another implementation, Block S120 detects a transition of the object, such as via sliding, from the first location, as detected in Block S110, to a second location outside of the active sensing area or to a second location within the active sensing area. Additionally, Block S120 can detect a change in an interfacing area of the object (e.g., a portion of the object contacting the tactile surface) as the object transitions with the active sensing area.

Block S130 of method S100 recites measuring an initial pressure of the mass of fluid in the variable volume. Generally, Block S130 functions to detect a first pressure (i.e., a baseline pressure) of the mass of fluid in the variable volume at some time before detection of removal of the object from the tactile surface in Block S120.

In one implementation, Block S130 can interface with the pressure sensor within the computing device to detect the first pressure at a time substantially corresponding to the time the first contact by the object is detected on the tactile layer in Block S110. The first pressure can indicate the pressure of the mass of fluid within the variable volume under the applied pressure of the first contact on the tactile surface at the peripheral region or at the deformable region, wherein the first contact deforms the deformable region. When the deformable region deforms, the volume of the variable volume changes, causing a pressure difference between a retracted deformable region and the deformed deformable region. Alternatively, the first pressure can be detected at a time substantially corresponding to the removal of the object from the tactile surface, thus indicating the pressure of the variable volume when the deformable region is substantially retracted and when no pressure is applied by the object onto the deformable region (or onto the peripheral region). The pressure sensor can be local to the deformable region (e.g., coupled to the variable volume) or remote from the deformable region (e.g., coupled to a fluid channel extending from the variable volume). Alternatively, Block S130 can interface with a strain gauge coupled to the tactile surface of the deformable region to detect a change in fluid pressure within the variable volume through correlation between a detected strain within the tactile layer at the deformable region when a force is applied to deform the deformable region and fluid pressure within the variable volume.

In Block S130, the pressure sensor can detect an object applying a pressure that exceeds a minimum specified pressure threshold from a predetermined pressure baseline and/or that is less than a maximum specified pressure threshold from a predetermined pressure baseline. The pressure sensor can also detect an object applying any pressure to the tactile surface greater than that required to detect the first contact in Block S110 at the touch sensor. The pressure baseline can correspond to atmospheric pressure, the pressure of the variable volume when the deformable region is substantially retracted, the pressure of the variable volume when the deformable is deformed a specified amount, or an otherwise suitable pressure baseline. The pressure baseline, alternatively, can dynamically and/or reconfigurably change as described in U.S. patent application Ser. No. 13/896,098, filed on 16 May 2013, which is herein incorporated in its entirety by this reference. The pressure sensor can be local to the deformable region (i.e., coupled to the variable volume) or remote to the deformable region.

In one implementation, Block S130 interfaces with a pressure sensor arranged within the variable volume and/or on the deformable region. For example, the pressure sensor can include a strain gauge arranged on or within the tactile layer at the deformable region, wherein a processor within the computing device correlates a change in output (e.g., a voltage output change) from the strain gauge as a change in pressure within the variable volume. Alternatively, Block S130 can interface with a pressure sensor arranged within or fluidly coupled to the fluid channel within the substrate. Similarly, Block S130 can interface with a pressure sensor coupled to a valve, to a fluid reservoir, and/or to the displacement device fluidly coupled to the variable volume, wherein fluid pressure within the variable volume is communicated to the pressure sensor, such as via the fluid channel fluidly coupled to the valve, the fluid reservoir, and/or the displacement device. An output of the pressure sensor can therefore indicate a pressure (or force) applied to a particular deformable region fluidly coupled to the variable volume. Alternatively, an output of the pressure sensor can indicate a pressure or force applied to any number of similar variable volumes fluidly coupled together via the fluid channel. Block S130 can additionally or alternatively sense a pressure wave within a variable volume and/or within a connected fluid channel and correlate a timing, magnitude, etc. of the pressure wave with an input on one or more deformable regions, and Block S160, as described below, can compare pressure differences and/or pressure waves output from multiple pressure sensors within the dynamic tactile interface to isolate a location and/or magnitude of an input on a particular deformable region or subset of deformable regions.

In one implementation, Block S130 polls the pressure sensors at regular intervals, such as every tenth of one second, at a refresh rate of the display, or at a polling rate of the pressure sensor, and such as only when the deformable region is fully expanded or at least 50% of fully expanded. In another example, Block S130 polls the pressure sense in response to detected contact on the tactile surface (e.g., as detected by the touch sensor in Block S110) proximal the deformable region, such as every twenty milliseconds after a contact is detected on the tactile surface within a threshold distance (e.g., five mm) of the perimeter of the deformable region. However, Block S130 can poll the pressure sensor to sense a second fluid pressure within the variable volume at any other interval and/or in response to any other event.

For example, Block S130 can register a fluid pressure difference that corresponds to the application of a force at any of twenty-six cavities all fluidly coupled to the same displacement device through a network of fluid channels. However, the pressure sensor can be fluidly coupled to the variable volume via any other arrangement and/or can be configured to detect a fluid pressure or a change in fluid pressure within the variable volume in any other suitable way.

Block S140 of method S100 recites detecting a second contact at a second location adjacent the deformable region. Generally, some time after detection of the removal of the object in Block S120, Block S140 detects a second contact by an object on the tactile layer at an active sensing area. Block S140 can detect the second contact by the same object that contacted the tactile surface in the first contact in substantially the same way as described in Block S110. Alternatively, the second contact can be the result of a contact by a second object, such as a second finger, a second stylus, another hand, etc. different from the (first) object. The second object can be of a different form than the first object. For example, if the first object is a finger, the second object can be a hand, a stylus, lips, etc., or if the first object is a stylus, the second object can be a hand, a finger, lips, etc. The second contact by the object can be static (i.e., the object can stay in one place) or dynamic (i.e., the object can move along the tactile surface).

Block S150 of method S100 recites detecting a second pressure of the mass of fluid at the remote pressure sensor. Generally, Block S150 detects a second pressure of the variable volume and functions in substantially the same manner as Block S130. In particular, Block S150 captures the second pressure reading at a time substantially corresponding to the time of the second contact by the object on the tactile layer. Thus, the second pressure can indicate the pressure of the variable volume filled with a mass of fluid under the applied pressure of the second contact on the tactile surface at the peripheral region or at the deformable region, wherein the second contact deforms the deformable region. When the deformable region deforms (e.g., is depressed) by the second contact, the volume of the variable volume changes and, therefore, the pressure within the variable volume changes, causing the second pressure to differ from the first pressure. Alternatively, Block S150 can detect the second pressure at a time substantially corresponding to removal of the object from the tactile surface, thus indicating the pressure of the variable volume when the deformable region is substantially retracted and when no pressure is applied by the object on the deformable region or the peripheral region. The pressure sensor can be local to the deformable region (i.e., coupled to the variable volume) or remote (i.e., coupled to a fluid channel extending from the variable volume or coupled to a remote fluid reservoir). Alternatively, Block S150 can measure the second pressure by interfacing with a strain gauge coupled to the tactile surface of the deformable region to detect a pressure applied to the deformable region by measuring a strain across a material within the deformable region. In another implementation of Block S150, Block S150 detects a second pressure substantially after the second contact but before the object is removed from the deformable region. Thus Block S150 detects a pressure corresponding to an equilibrated pressure of the variable volume when the object has deformed the deformable region. In this implementation, the equilibrated pressure serves to prevent erroneous pressure readings due to fluid movement when the fluid is displaced from the variable volume.

Block S160 of method S100 recites, in response to a pressure difference between the first pressure and the second pressure, interpreting the first contact and the second contact as a gesture. Generally, Block S160 functions to process a set of pressure data detected in Blocks S130 and S150 and a touch sensor data from Blocks S110 and S140 and interpret the set of pressure data to detect a change in fluid pressure and, in response to a detected change in fluid pressure, interpret the touch sensor data as an input to the computing device.

In one implementation, Block S130 interfaces with the pressure sensor to detect a first pressure within the variable volume. Block S130 can also store a baseline fluid pressure, such as a pressure within the variable volume substantially soon after the deformable region is transitioned into the expanded setting, and Block S150 can subsequently register and store a second fluid pressure when a force is applied to the deformable region in the expanded setting. Once Block S150 detects a second fluid pressure, Block S160 can further compare the second fluid pressure to a first fluid pressure, to a reference fluid pressure, and/or to a fluid pressure in another discrete fluid system within the computing device, etc., to calculate a change in fluid pressure within the variable volume. However, Block S160 can function in any other way to detect a change in fluid pressure within the variable volume.

Block S160 can also interpret contact by the object on the tactile surface as an input corresponding to an image of an input key in response to a timing and a sequence of the change in fluid pressure and the contact on the tactile surface. Generally, Block S160 functions to aggregate tactile surface contact information (e.g., location, motion, timing) and fluid pressure data to identify a selection of the displayed input key. Block S160 can compare a timing and/or magnitude of a change in fluid pressure within the variable volume and a timing, direction of motion, contact path, initial location, release location, a contact area of finger, stylus, or other implement, a rate or magnitude of detected pressure difference, etc. to a preset timing, preset sequence model, input definition, etc. to ascertain the validity of a contact as selection of the corresponding input key.

In an example implementation, Block S130 detects a first pressure within the variable volume in the expanded setting, and Block S160 identify a first input type corresponding to the virtual key (e.g., ‘a’) in response to contact on the tactile surface over the displayed image that does not increase the fluid pressure within the variable volume by more than a threshold change, and Block S160 further identifies a second input type corresponding to the virtual key (e.g., ‘A’) in response to contact on the tactile surface over the displayed image that increases the fluid pressure within the variable volume by more than the threshold change.

In a similar example implementation, Block S160 identifies an input corresponding to the input key in response to detected contact on the tactile surface proximal a third corner of the virtual key opposite the first corner of the virtual key and detected motion of the contact from proximal the third corner to proximal the first corner. In this example implementation, Block S160 can identify the input further based on a rise in fluid pressure within the variable volume adjacent the deformable region succeeding (i.e., after) motion of the contact from proximal the third corner to proximal the first corner of the virtual key. Alternatively, Block S160 can identify an input of a first type corresponding to the input key (e.g., ‘a’) based on detected contact motion from proximal the third corner to proximal the first corner and without a detected pressure difference greater than the threshold change, and Block S160 can identify an input of a second type corresponding to the input key (e.g., ‘A’) based on detected contact motion from proximal the third corner to proximal the first corner with a detected pressure difference greater than the threshold change.

Block S160 can define the active sensing area that overlaps and/or lies adjacent any portion of the deformable region in the expanded setting. Block S130 can thus detect pressures within the variable volume, and Block S110 and Block S140 can detect a single input or set of inputs (e.g., movement of an input) along, around, adjacent, or (hovering) over, etc. the deformable region. Block S160 can thus identify an input and/or a type of input on the dynamic tactile interface based on an input path (e.g., a path traversed by an object along the tactile surface) and a detected pressure difference within the variable volume adjacent the deformable region. For example, Block S160 can detect an input of a first type that moves in a first direction along a linear-ridge-shaped deformable region and coincides with a pressure increase within the adjacent variable volume, and Block S160 can detect an input of a second type that moves in a second direction opposite the first direction along the deformable region and coincides with a pressure increase within the adjacent variable volume. However, method S100 can detect an input in any other way and in response to any other detected touch and detected pressure difference for a deformable region of any suitable formation and an active sensing area of any other geometry or position.

Block S160 can further implement rules defining input validity of a contact that crosses into the active sensing area (e.g., that has an initial contact location outside of the active sensing area) and/or that crosses out of the active sensing area (e.g., that has a release location outside of the active sensing area). Block S160 can also implement direction of motion definitions to identify the contact as an input, such as motion of the contact toward the deformable region or across a border of the active sensing area. Furthermore, Block S160 can set event timing or event sequence definitions for the contact, such as an order of initial contact within the active sensing area, a release of the contact from the active sensing area, an initial change in fluid pressure within the variable volume adjacent the deformable region, a peak fluid pressure magnitude, a return of the variable volume fluid pressure to (approximately) a first fluid pressure, etc.

However, Block S160 can implement any other position, motion, time, and/or pressure data corresponding to any or any combination of the peripheral region, the deformable region, and the image of the input key to identify an input into a computing device.

Blocks S160 can interface with a touch sensor controller, a host CPU, a touchscreen CPU, and/or any other controller or processor within the computing device, to define the active sensing area that specifies areas of the tactile surface at which Blocks S160 may respond to a contact, such as by a finger or by a stylus. The active sensing area may therefore either implicitly or explicitly specify one or more regions of the tactile surface at which Blocks S110 and S140 may ignore contact by a finger, a stylus, etc. A processor within the computing device can thus implement method S100 by responding to an input at the active sensing area, as described below, and by ignoring an input outside the active sensing area. Blocks S160 can also define ranked active sensing areas, such as a primary active sensing area proximal the center of the displayed input key, a secondary active sensing area proximal and within a perimeter of the displayed input key, and a tertiary active sensing area proximal the deformable region. The processor within the computing device can thus further implement method S100 by responding to an input at the primary active sensing area based on a first set of timing, pressure, and/or motion definitions, responding to an input at the secondary active sensing area based on a second set of timing, pressure, and/or motion definitions, and responding to an input at the tertiary active sensing area based on a third set of timing, pressure, and/or motion definitions or by ignoring the input at the tertiary active sensing area.

Block S170 of method S100 recites, in response to the gesture, executing a command corresponding to the gesture at a processor. Generally Block S170 functions to execute a program (or to modify a portion of a program), display an image, and/or modify an input according to the gesture interpreted from the contacts in Block S160.

Block S170 can interface with a processor that can also interpret the contacts in Block S160 as a gesture and generate a command corresponding to the gesture. Substantially at the time of the generation of the command, Block S170 can execute the command. In one implementation, the gesture corresponding to the capitalization of an alphanumeric key yields a command that tells a word processing application to capitalize a displayed letter corresponding to the alphanumeric key (i.e., “A”). Block S170 can execute the command substantially at the time of generation of the command, displaying a capitalized letter or number within a window of a word processing application on a digital display. Alternatively, Block S170 can execute the command at any time after the interpretation of the input and the generation of a corresponding command.

In another implementation, Block S170 can selectively execute commands generated from contacts interpreted as gestures in Block S160. For example, Block S160 can interpret a gesture indicating the capitalization of a letter input into a word processing program and generate a command corresponding to the display of the letter in a word processing program window. Block S170 can recall preceding executed commands (e.g., preceding letters) and, based on the preceding inputs, selectively execute the current command. For example, Block S170 can execute the capitalization command based on a preceding input corresponding to the display of a space in a word processing application. However, if the current command for capitalization is preceded by one or more lowercase letter inputs, Block S170 can disregard the capitalization command as incidental. Alternatively, Block S170 can execute a command to display a warning icon asking the user to verify the capitalization of the input letter.

In another implementation, Block S170 can modify the active sensing area in response to a detected fluid pressure difference in the corresponding (i.e., adjacent) variable volume filled with a mass of fluid, such as temporarily shifting the active sensing area to overlap with the deformable region or by temporarily changing the size and/or geometry of the active sensing area for a period of time (e.g., 500 ms) after a detected fluid pressure difference that exceeds a threshold pressure difference. Block S170 can additionally or alternatively modify the active sensing area in response to a detected finger, stylus, or other implement proximal the deformable region and/or the peripheral region. For example, Block S170 can modify the size, shape, and/or position of the active sensing area in response to detection of a finger hovering over the peripheral region. In this example, Block S170 can also modify the size, shape, and/or position of the active sensing area based on the vertical distance of the finger (or other object) from the peripheral and/or deformable region, such as by increasing the size of the active sensing area as the distance of the finger from the peripheral region decreases. In this example, Block S170 can also modify the size, shape, and/or position of the active sensing area based on amount of time that the finger or other implement hovers over the peripheral and/or deformable region, such as by increasing the size of the active sensing area proportionally with the amount of time that the finger hovers over the peripheral region. However, Block S170 can function in any other way to define the active sensing area of any other shape, form, geometry, and/or arrangement. In other implementations, Block S170 can transition the deformable region into a slider, a ring, a trackball, or any other formation over the peripheral region.

In one example implementation, Block S110 can detect the origin of a contact, that is, the initial contact point of the contact on the tactile surface, compare the origin to the active sensing area, and discard the contact if the origin falls outside of the active sensing area. However, if the origin falls within the active sensing area, Block S110 can pass the contact origin, initial contact time, a contact release location, a contact release time, a motion path of the contact, etc. to Block S160, such as shown in FIG. 1. In another implementation, Block S110 can detect a contact crossing a perimeter of the active sensing area and pass the contact crossing time, an initial contact time, a release location of the contact, a motion path of the contact, etc. to Block S160 accordingly. In yet another implementation, Blocks S110 and S140 can detect a contact that terminates within the active sensing area and, in response, pass the contact information to Block S160. In still another implementation, Blocks S110 and S140 can detect or characterize a gesture within the active sensing area and, in response, pass the gesture information to Block S160. For example, Blocks S110 and S140 can identify a contact path from side or corner of the active surface area to an opposite or adjacent side or corner of the active surface area, such as toward the deformable region. Blocks S110 and S140 can also detect an input or gesture above but not contacting the tactile surface (e.g., at the peripheral and/or at the deformable region) and subsequently pass this information to Block S160. For example, method S100 can interface with an ultrasound sensor to detect a finger, stylus, and/or other implement on or near the tactile surface. However, Blocks S110 and S140 can detect any other contact originating within, terminating within, and/or crossing into or out of the active sensing area in any other suitable way. Blocks S110 and S140 can also characterize the contact in any other suitable way and/or pass any other relevant contact information to Block S160.

In one example implementation, Block S110 detects a first contact on the tactile surface at an active sensing area (e.g., sensed by a touch sensor adjacent the display). Block S120 then detects the removal of the contact from the tactile surface at the active sensing area (e.g., sensed the object lifted off the surface by a touch sensor adjacent the display). In Block S130, a pressure sensor detects the fluid pressure within the variable volume at a first time corresponding to the absence of the contacting object on the tactile surface (e.g., via a pressure sensor coupled to a fluid channel connected to the variable volume), and stores the detected fluid pressure as a first pressure. Block S140 subsequently detects a second contact at the active sensing area at a second time that succeeds the removal time by less than a maximum threshold time, by more than a minimum threshold time, or by both less than a maximum threshold time and more than a minimum threshold time. Block S150 then detects a second pressure of the variable volume corresponding to the second contact. Thus, Block S160 can identify an intentional input corresponding to the virtual key and handle the input accordingly. Therefore method S100 can accommodate an input that both applies a pressure to the tactile surface at the deformable region, increasing fluid pressure within the adjacent variable volume, and that contacts the adjacent active sensing area substantially simultaneously (i.e., within the threshold time). However, if the detected pressure difference does not exceed the first pressure difference, if the detected contact at the active sensing area does not follow the pressure difference within the maximum and/or minimum time thresholds, or if both the detected pressure difference does not exceed the first pressure difference and the detected contact at the active sensing area does not follow the pressure difference within the maximum, the minimum, or both the maximum and the minimum time thresholds, method S100 can interpret the input as unintentional.

In another example implementation, Block S110 detects a contact on the tactile surface at an active sensing area (e.g., sensed by a touch sensor adjacent the display). In Block S130, a pressure sensor detects the fluid pressure within the variable volume at a first time corresponding to the first contact with the tactile surface (e.g., via a pressure sensor coupled to a fluid channel connected to the variable volume), and stores the detected fluid pressure as a first pressure. Block S120 then detects the removal of the contact from the tactile surface at the active sensing area (e.g., sensed the object lifted off the surface by a touch sensor adjacent the display). Block S140 subsequently detects a second contact at the active sensing area at a second time that succeeds the removal time by less than a maximum threshold time, and/or by more than a minimum threshold time. Block S150 then detects a second pressure of the variable volume corresponding to the second contact. Block S160 processes the first pressure and the second pressure to detect a change in pressure; based on the change in pressure, processes the first contact and the second contact as an input gesture; and in response to the input gesture, generates an executable command corresponding to the input gesture. Finally, Block S170 executes the executable command.

In yet another implementation, Block S110 detects a contact on the tactile surface at an active sensing area (e.g., sensed by a touch sensor adjacent the display). Block S130 interfaces with a pressure sensor to detect the fluid pressure within the variable volume at a first time corresponding to the first contact with the tactile surface (e.g., via a pressure sensor coupled to a fluid channel connected to the variable volume), and stores the detected fluid pressure as a first pressure. Block S120 then detects the removal of the contact from the tactile surface at the active sensing area (e.g., sensed the object lifted off the surface by a touch sensor adjacent the display). Block S140 subsequently detects a second contact at the active sensing area at a second time that succeeds the removal time by less than a maximum threshold time, by more than a minimum threshold time, or by both less than a maximum threshold time and more than a minimum threshold time. Block S150 then detects a second pressure of the variable volume corresponding to the second contact. Method S100 further detects the return of the pressure of the variable volume to the first pressure after the object is removed from the tactile surface following the second contact.

Method S100 also can detect an intentional input corresponding to the virtual key according to the detected rise and return of the variable volume fluid pressure followed by contact and subsequent release at the active sensing area. For example, method S100 can identify an input based on detected motion of an object across the tactile surface, over the deformable region, and terminating at the active sensing region. In this example implementation, if the change in fluid pressure in the variable volume filled with a mass of fluid does not occur within a threshold period of time, if the contact at the active sensing area does not occur within a threshold period of time after the rise or fall of the fluid pressure, and/or if contact is not released from the tactile surface at the active sensing area (e.g., after a threshold period of time after initial contact at the active sensing area), method S100 can identify the contact as an incidental input.

In yet another example implementation, method S100 again sets a first pressure within the variable volume filled with a mass of fluid in the expanded setting, identifies a first input type corresponding to the virtual key (e.g., ‘a’) in response to contact on the tactile surface—over the displayed image on the active sensing area—that does not increase the fluid pressure within the variable volume by more than a threshold change, and identifies the second contact at the deformable region as corresponding to the virtual key (e.g., ‘A’) in response to contact on the tactile surface over the displayed image that increases the fluid pressure within the variable volume filled with a mass of fluid by more than the threshold change.

In another example implementation, method S100 detects a first pressure within the variable volume filled with a mass of fluid in the expanded setting, identifies a first input type corresponding to the virtual key (e.g., ‘a’) in response to contact on the tactile surface over the displayed image that increases the fluid pressure within the variable volume filled with a mass of fluid by more than the threshold change, and identifies the second contact at the deformable region as corresponding to the virtual key (e.g., ‘A’) in response to contact on the tactile surface over the displayed image on the active sensing area that does not increase the fluid pressure within the variable volume by more than a threshold change.

In a similar example implementation, method S100 transitions the deformable region into a cusp-, corner-, or boomerang-shaped ridge adjacent a first corner of the displayed image of the input key. Method S100 further identifies an input corresponding to the input key in response to detected contact on the tactile surface proximal a third corner of the virtual key opposite the first corner of the virtual key and detected motion of the contact on across tactile surface from proximal the third corner to proximal the first corner. In this example implementation, method S100 can identify the input further based on a rise in fluid pressure within the variable volume adjacent the deformable region succeeding motion of the contact from proximal the third corner to proximal the first corner of the virtual key. Alternatively, method S100 can identify an input of a first type corresponding to the input key (e.g., ‘a’) based on detected contact motion from proximal the third corner to proximal the first corner and without a detected pressure difference greater than the threshold change, and method S100 can identify an input of a second type corresponding to the input key (e.g., ‘A’) based on detected contact motion from proximal the third corner to proximal the first corner with a detected pressure difference greater than the threshold change. However, method S100 can detect and implement any other position, motion, time, and/or pressure data corresponding to the peripheral region, the deformable region, and/or the image of the input key to identify an input into the connected computing device.

In another example implementation, method S100 transitions the deformable region into a guide substantially centered over the displayed image of the input key (e.g., an ‘F’ key). Method S100 sets the active sensing area surrounding the deformable region and then identifies an input corresponding to the input key in response to detected depression of the deformable region (e.g., based on a change in fluid pressure within the corresponding variable volume filled with a mass of fluid) following by contact on the peripheral region substantially circumferentially about the deformable region (e.g., based on an output of the touch sensor). In this example, method S100 can thus expand the deformable region to provide a tactile indication of a particular key (e.g., the ‘F’ key) and capture a selection for the particular key based on a pressure difference and touch input sequence.

In yet another example implementation, method S100 detects an input based on a detected change in fluid pressure within the variable volume filled with a mass of fluid by a first input mechanism (e.g., a finger, a stylus, etc.) and a change in an output of the touch sensor in response to a detected contact on or hover over the active sensing area by a second input mechanism (e.g., a second finger, etc.).

In one variation, method S100 functions to alter the position of one or more deformable regions of the dynamic tactile interface relative to an adjacent peripheral region(s). For example, method S100 can control a positive displacement pump to displace fluid from a reservoir, through a fluid channel defined by the substrate, into the variable volume adjacent a deformable region to expand the tactile surface at the deformable region above the tactile surface at the peripheral region. Method S100 can further transition multiple deformable regions from the retracted setting to the expanded setting in unison, such as a set of deformable regions arranged over, but not overlapping, a set of images of various characters of an alphanumeric keyboard, thereby providing tactile guidance to the user while the user enters text into the computing device via the alphanumeric keyboard.

In one example, method S100 displays an image of a home screen on a digital display of a mobile computing device (e.g., a smartphone, a tablet) that incorporates a dynamic tactile interface, each deformable region of the dynamic tactile interface initially in the retracted setting. In this example, once a user selects a native text-based application (e.g., a native SMS text messaging application, an email application, calendar application, a search bar within a web browser), the display displays a new image of an interface within the native application including a 26-key alphanumeric keyboard, and the dynamic tactile interface transitions the set of deformable regions into the expanded setting in which each deformable region substantially aligns with one key in the displayed keyboard.

In another example, method S100 is implemented on a console display including a dynamic tactile interface and arranged within a road vehicle. In this example, once a user turns the vehicle on, the console display displays an image of a stereo control interface including multiple stereo control keys (e.g., volume, play, track forward, rewind, saved radio stations, etc.), and the dynamic tactile interface transitions the set of deformable regions into the expanded setting in which each deformable region substantially aligns with one key in the displayed stereo control interface.

Method S100 can further output an image from the digital display and through all or a portion of the peripheral region of the tactile layer. In one example, a display within the computing device can render an image of an alphanumeric character (e.g., ‘a’, ‘A’, ‘1’, etc.) or other textual symbol (e.g., ‘?’, ‘.’, ‘%’, etc.) on the display beneath the peripheral region such that the alphanumeric character is projected through the tactile layer and is thus visible to the user at the peripheral region. In this example, display can also display multiple images of various alphanumeric characters, such as a complete keyboard including twenty-six characters of the English alphabet, wherein each image corresponds to one character in the alphabet and to one peripheral region adjacent one corresponding deformable region. In other examples, the display renders a send button within a native messaging (e.g., SMS text message, email) application executing on the computing device, a home screen icon for a native application executing on the computing device, or a search icon within a web browsing application executing on the computing device. Therefore, as in the foregoing examples, the display can display the image of input key that corresponds to a particular input, type of input, or command for the computing device. The displayed image of input key can also correspond to multiple inputs, input types, and/or command. For example, as described above, a first input type on an active region corresponding to an image of an input key can correspond to a lowercased alphanumeric character, and a second input type on the active region can correspond to an uppercased alphanumeric character. However, the display can display one or more images of one or more input keys in any other suitable way, in any other suitable format, and in any other suitable arrangement on the display.

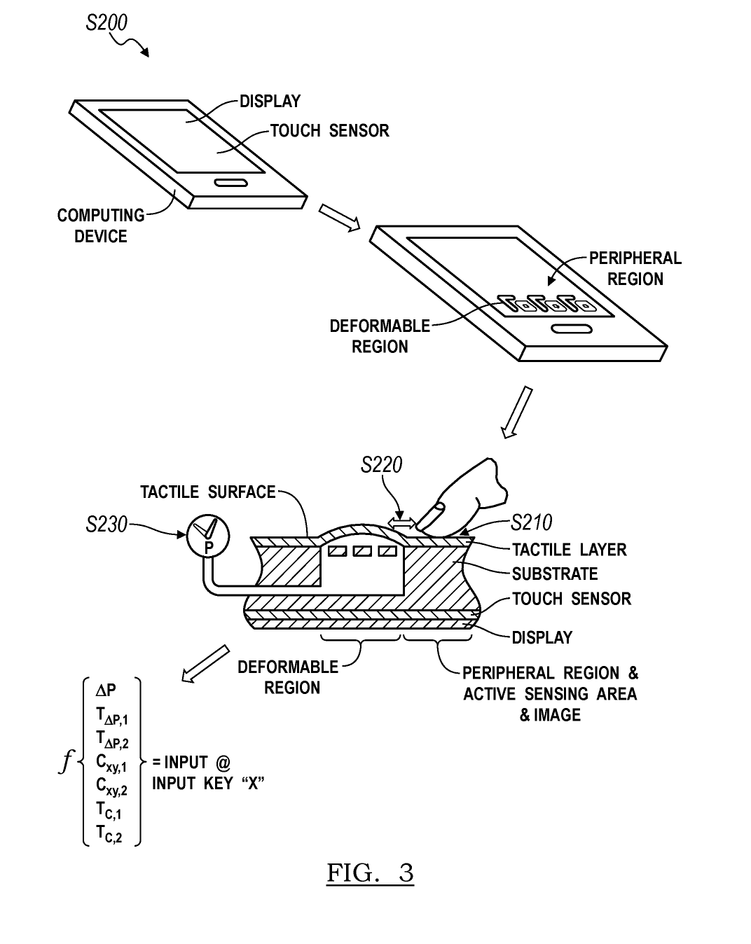

Method S100 further defines an active sensing area corresponding to the input key for a touch sensor coupled to the display, the active sensing area including the peripheral region adjacent the image and excluding the deformable region. Generally, Blocks S110 and S140 defines a region of the tactile surface on which contact is registered by the adjacent touch sensor and/or a processor within the computing device, the active sensing area corresponding to the image of the input key projected from the display through the peripheral region of the tactile layer. Blocks S110 and S140 can define the active sensing area that extends over the full area of the displayed input key, that extends over less than the full area of and fully within the displayed image of the input key, that extends over the full area of the peripheral region, that extends over less than the full area of and fully within the peripheral region, that extends over overlapping areas of the peripheral region and the displayed image of the input key, that is adjacent but does not overlap the deformable region and the displayed image, or according to any other arrangement of the peripheral region and/or the displayed image of the input key. Blocks S110 and S140 can also define the active sensing area that extends up to a perimeter (i.e., border) of the deformable region or that is offset from the perimeter of the deformable region. Blocks S110 and S140 can define the active sensing area that includes a perimeter that follows a contour of the deformable region, a perimeter of the peripheral region, and/or a perimeter of the displayed image of the input key. Blocks S110 and S140 can also define different or unique shape, geometries, and/or locations of active sensing areas adjacent images of different input keys, such as shown in FIG. 3. However, Block S110 and S140 can define the active sensing area that is of any other shape, geometry etc. relative to one or more of the deformable region, the peripheral region, the displayed image of the input key, etc.

In one example implementation described above, the dynamic tactile interface transitions the deformable region into the expanded setting, and Block S130 detects a fluid pressure within the variable volume at a first time and stores the fluid pressure for the first time as a first fluid pressure. Block S150 subsequently detects a second fluid pressure within the variable volume at a second time (e.g., in response to a force applied to the deformable region) and Block S160 calculates a fluid pressure difference at the second time by comparing the second fluid pressure to the first fluid pressure and further detects a subsequent contact on the tactile surface at the active sensing area at a third time succeeding the second time. For the detected pressure difference that exceeds a threshold value and for the detected contact at the active sensing area at the third time that succeeds the second time by less than a maximum threshold time, Block S160 can identify an intentional input corresponding to the virtual key and thus handle the input according to a command, input, etc. associated with the input key, as shown in FIG. 3. Block S110 can therefore handle an input that applies a force applied to the tactile surface at the deformable region (that increases fluid pressure within the adjacent variable volume) and that contacts the adjacent active sensing area substantially in sequence and/or simultaneously (e.g., within the threshold time). However, if the detected pressure difference does not exceeds the first pressure difference and/or if the detected contact at the active sensing area does not follow the pressure difference within the maximum (and/or minimum) time threshold(s), Block S160 can interpret the input as unintentional.

In a similar example implementation described above, Block S130 can again record a first fluid pressure within the variable volume in the expanded setting, detect a fluid pressure increase over the first fluid pressure greater than a threshold change at a second time, and detect a return to approximately the first fluid pressure (e.g., within a first threshold) at a third time. Block S140 can subsequently detect a contact on the tactile surface at the active sensing area at a fourth time following the second time (and/or the third time). For a sequence of the detected rise and return of the fluid pressure within the variable volume and subsequent detected contact at the active sensing area at the fourth time that succeeds the second time by less than a maximum threshold time, Block S160 can identify an intentional input corresponding to the virtual key and thus handle the input accordingly. Block S160 can additionally or alternatively identify an intentional input corresponding to the virtual key according to the detected rise and return of the variable volume fluid pressure followed by contact and subsequent release at the active sensing area. However, if the change in fluid pressure in the variable volume does not occur within a threshold period of time, if the contact at the active sensing area does not occur within a threshold period of time after the rise or fall of the fluid pressure, and/or if contact is not released from the tactile surface at the active sensing area (e.g., after a threshold period of time after initial contact at the active sensing area), Block S160 can identify the contact as an incidental input.

In an example implementation, a finger rests on the active sensing area corresponding to the deformable region, wherein the deformable region is tactilely distinguishable from the peripheral region and raised above the peripheral region (e.g., in the expanded setting). The peripheral region corresponds to an image of a key rendered on a display that lies under the tactile layer. The image of the key (e.g., ‘a’) is visible through the tactile layer. A capacitive touch sensor detects the finger resting on the tactile surface. A pressure sensor takes a first pressure reading, establishing the pressure of the variable volume beneath the deformable region when the deformable region is substantially retracted from the fully expanded state. At some time, the finger lifts off the tactile surface. Within a specified time period (e.g., 500 millisecond to 1 second), the finger returns to the tactile layer and depresses the deformable region on which it previously rested, thereby constituting a second contact. The pressure sensor (or another pressure sensor) takes a second pressure measurement of the variable volume beneath the deformable region. A processor determines the difference between the first and second pressures and the location of the first and second contacts. From the pressure difference and the location of the first and second contacts, the processor generates a command that specifies display of the image represented by the key (e.g., specifying a command for displaying the letter ‘a’). The processor (or other processor within the computing device) executes the command by controlled the display to render the image represented by the key (e.g., the letter ‘a’).

In another example implementation, a finger rests on the active sensing area corresponding to the deformable region, wherein the deformable region is tactilely distinguishable from the peripheral region and raised above the peripheral region in the expanded setting. The peripheral region corresponds to an image of a key rendered on a display that lies under the tactile layer. The image of the key (e.g., ‘a’) is visible through the tactile layer. A capacitive touch sensor detects the finger resting on the tactile surface. At some time, the finger lifts off the tactile surface. A pressure sensor takes a first pressure reading, establishing the pressure of the variable volume beneath the deformable region when the deformable region is substantially retracted from the fully expanded state (e.g., at a time after the first contact and before the second contact). Within a specified time period (e.g., 500 millisecond to 1 second), the finger returns to the tactile layer and depresses the deformable region on which it previously rested, thereby constituting a second contact. The pressure sensor (or another pressure sensor) takes a second pressure measurement. A processor determines the difference between the first and second pressures and the location of the first and second contacts. From the pressure difference and the location of the first contact and second contact, the processor generates a command that specifies display of the image represented by the key (e.g., specifying a command for displaying the letter ‘a’). The processor interprets the first contact with the image of the key as an input for displaying the image associated with the key. Upon the first contact, the processor generates a command that specifies one form of the image of the key (e.g., lowercase ‘a’). The second contact can verify that, indeed, that form of the image of the key should be displayed. Alternatively, the second contact can specify that an alternative form of the image of the key should be displayed (e.g., uppercase ‘A’). Alternative forms of the image of the key can be italicized, bold, underlined, struck through, of a different typeface, of a different font, of a different background color, and/or of a different font color. Alternative forms of the image key can also include images of characters related to the character displayed on the image of the key, images of characters corresponding to characters from other alphabets, such as Cyrillic, German, Chinese, etc. The processor (or other processor) executes the command to display the image represented by the key.

### 4. Slide Gesture

As shown in FIG. 2, method S200 includes detecting and interpreting user interaction with the dynamic tactile interface. In particular, method S200 includes detecting an object contacting the tactile surface; detecting the object moving along the tactile surface; measuring an initial pressure of the mass of fluid in the variable volume when there is no contact with the deformable region; measuring a second pressure of the mass of fluid in the variable volume substantially at (or after) the time when the object contacts the deformable region; interpreting the movement of the object along the tactile surface and the pressure difference as an input gesture; and executing a command that corresponds with that input gesture.

Block S210 of method S200 includes detecting an object contacting the tactile surface at an active sensing area. Block S210 functions in substantially the same manner as Block S110 of the method S100 described above. Generally, Block S210 of method S200 detects the first contact by the object on the tactile layer at an active sensing area. In one implementation, an object such as a finger, a stylus, etc. contacts the tactile surface, and Block S210 of method S200 detects the first contact on the tactile surface at an active sensing area adjacent a deformable region and corresponding to a touch sensor. In this implementation, the first contact can touch, slide across, rest on, hover over, or otherwise contact the tactile surface; in particular, Block S210 can detect the first contact that touches, slides across, rests on, hovers over etc. the tactile surface at the peripheral region, such as by interfacing with a capacitive, optical, resistive or other suitable touch sensor arranged within the computing device.

In another implementation, an object such as a finger, a stylus, etc. contacts the tactile surface, and Block S210 of method S200 detects the first contact by the object on the tactile surface at an active sensing area corresponding to the deformable region. Thus the first contact with the tactile surface can cause inward deformation of the deformable region, such as when the deformable region is in the expanded setting.

In yet another implementation, the first contact touches, slides across, rests on, hovers over etc. the tactile surface at the peripheral region and is detected by a touch sensor, such as a capacitive, optical, or resistive touch sensor in Block S210. The first contact with the tactile surface further causes deformation of the deformable region.

Block S220 of the method S200 includes detecting a transition of the object along the tactile surface. The transition of the object along the tactile surface can include a slide that is substantially linear, circular, curvilinear, hyperbolic, elliptical, rectangular, triangular, random, and/or a path of any other suitable geometry across the tactile surface. The object can travel along the surface within an active sensing area. Alternatively, the object can exit the active sensing area at some point on the path of the object. The object can also originate movement at a non-active sensing area, an active sensing area, and/or a deformable region. The object can cross the deformable region at any point on the path of the object. Likewise, the object can terminate movement at an adjacent deformable region, at a non-active sensing area, at another separate active sensing area, at a non-adjacent deformable region, and/or at any region or area on the computing device.

Block S230 of method S200 includes detecting a first pressure of the variable volume. Block S230 acts substantially in the same way as Block S130. Block S230 can detect the first pressure of the variable volume prior to a detected transition of the object from the first contact location in Block S220. Alternatively, Block 220 can detect the first pressure following initiation of the transition of the object from the first contact location toward the second contact location on the computing device. The first pressure detected in S230 can correspond to the pressure of the first contact detected in Block S210, when the first contact corresponds with the deformable region, an active sensing area, a non-active sensing area, and/or the peripheral region.

Block S240 of method S200 includes detecting a second pressure of the variable volume, the second pressure corresponding to a pressure detected at the end of the transition detected in S220. The pressure can correspond to the object contacting the deformable region, an active sensing area, a non-active sensing area, and/or the peripheral region. Block S240 can act in substantially the same way as Block S150.

Block S250 of method S200 interprets the first contact, the transition, the first pressure and the second pressure as an input gesture and generates a command corresponding to the gesture. Block S250 can act in substantially the same way as Block S160. For example, Block S250 can interpret the transition in substantially the same way as Block S160 interprets the second contact as a verification of the first input and/or as a secondary input used to modify the first input, etc.

In an example application of method S200, a user slides an object across the tactile surface up to the deformable region; when the object reaches the deformable region, the object depresses the deformable region causing a change in the second pressure read by the pressure sensor. The first contact of the object in this example application corresponds to a location on the tactile surface of a display where an image of an alphanumeric key lies (e.g., a key for the letter “a”). In this example application, the first contact is interpreted as an input gesture in Block S250 indicating a lowercase letter (e.g., “a”). When the user slides the object across the tactile surface as in method S200 (or removes the object as detected in Block S120 of method S100 and makes a second contact as detected in Block S140 of method S100), the contact with and depression of the deformable region is interpreted as an input gesture indicating capitalization of the letter (e.g., “A”) by Block S250 (or by Block S160 of method S100, as described above). Subsequently, Block 260 executes the command corresponding to the inputs generated in Block S250, thereby displaying a capitalized letter (e.g., “A”) on the display.

### 5. Example Implementations

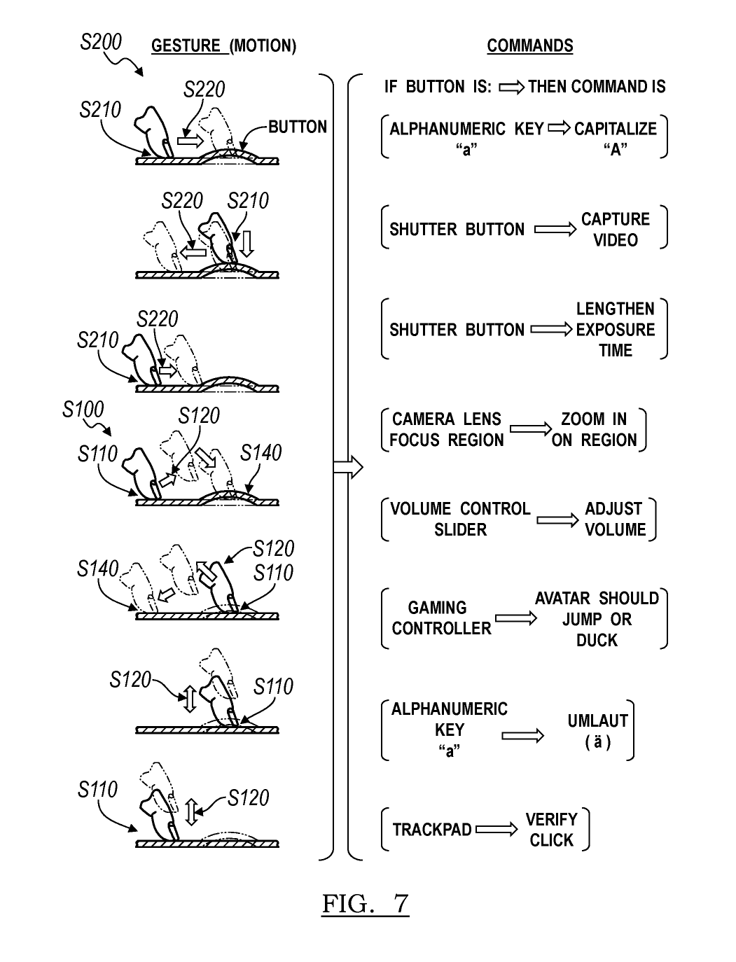

As shown in FIG. 7, in an example implementation, a user can interface with a dynamic tactile interface arranged over a display on a camera executing method S100. The display shows a recent photograph taken by the user. By pressing on the dynamic tactile interface over the display with a finger, the user highlights a portion of the photograph, such as a face, which the user would like to edit. By applying pressure on a deformable region, thereby deforming the region and causing a change in the pressure within the variable volume, the user indicates that the software installed on the camera should zoom in on the portion of the photograph the user highlighted in the first contact. The second contact and supplied pressure difference indicate how far the camera software should zoom in on the portion of the photograph. Alternatively, the pressure difference can indicate how much the software should change the photograph's contrast, brightness, hue, etc. The pressure difference can also indicate that the software should crop the photograph around the highlighted area.

In a related example implementation, method S100 can be used by a user interacting with a dynamic tactile interface over a display on a tablet or mobile phone, the display showing the output of a camera application. A user selects a portion of the image displayed as the output of the camera application with a finger by making a first contact with the tactile surface at the area corresponding to the portion of the image on which the user wishes to focus a camera lens with the device and control the camera application. The user can remove the finger from the tactile display and subsequently make a second contact with the tactile surface at an area corresponding with a deformable region. The second contact can cause inward deformation of the deformable region. The deformable region can be adjacent an image of a button rendered on the display and indicating a still photograph should be taken, or the deformable region can correspond to a portion of the image the user wishes to focus on in the still photograph. The camera application can interpret the magnitude of the pressure difference between the baseline first pressure and the second pressure corresponding to the second contact as a command indicating exposure time for the still photograph or the, contrast, hue, brightness, and/or zoom of the still photograph. The pressure difference can also indicate a video should be captured by the camera application rather than a still photograph. For example, Block S2650 can interpret no pressure difference between the first and second contacts as a command to capture a digital still photograph.

In another example implementation, method S100 can be used by a user interacting with a dynamic tactile interface arranged over a display on a tablet computer, which displays a volume control for a music application executing on the device. To adjust the output volume of music played on the device through the music application, a user touches the dynamic tactile interface at a deformable region corresponding to the volume control. Thus, when the user touches the dynamic tactile interface at the area corresponding to the volume control, the user deforms the deformable region, thereby changing the pressure of the variable volume adjacent (e.g., under) the deformable region. Block S160 can interpret this input as a command to adjust a volume output of the device according to the magnitude of the pressure change within the variable volume. The volume of the music can also be adjusted by the user performing a slide gesture along an area of the tactile surface corresponding to the volume control, the user applying a second pressure to a deformable region at some point along the volume control corresponding to the output volume of music the user desires, the applied second pressure verifying the output volume selected by the user.

In a similar example implementation, method S100 can be used by a user interacting with a dynamic tactile interface arranged over a display on a tablet computer, which displays a user interface including a list of available songs within a music application executing on the device. To choose a song, the user can scroll through the list of songs by sliding a finger along the tactile surface and then depressing the finger on a deformable region at an area corresponding to a displayed image of a song title the user wishes to hear. Thus method S100 can interpret the finger sliding along the tactile surface as the first contact and depression of the deformable region as the second contact. Method S100 can also detect a first pressure and a second pressure and process the first pressure and the second pressure to determine a pressure difference. The pressure difference acts as a verification of the selection. The pressure difference can further be used to indicate to the music application that a sample of the selected song should be played so long as the applied second pressure is maintained.

In another example implementation, method S100 can be used on a gaming controller with a dynamic tactile interface. A player interacting with the gaming controller can slide a finger across the dynamic tactile interface indicating an associated the image of a player avatar should move in a specified direction (e.g., when the user slides a finger to the right, the image of the player avatar should move forward along the ground). When the user applies a pressure corresponding to a deformable region the gaming controller together with the slide gesture, the device interprets the gesture and the pressure as a command to indicate that the image of the player avatar should move out of the plane indicated merely by the slide. The pressure coupled with a slide toward the right, for example, indicates the image of the player avatar should jump. Likewise, a slide toward the left can indicate the image should move backward. The slide toward the left in addition to an pressure difference due to the depression of the deformable region indicates the image of the player avatar should duck, jump down, or move in a downward direction.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, native application, frame, frame, hardware, firmware, or software elements of a user computer or mobile device, or any suitable combination thereof. Other systems and methods of the embodiments can be embodied and/or implemented at least in part as a machine configured to receive a computer-readable medium storing computer-readable instructions. The instructions can be executed by computer-executable components integrated by computer-executable components integrated with apparati and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, though any suitable dedicated hardware device can alternatively or additionally execute the instructions.

A person skilled in the art will recognize from the previous detailed description, the figures, and the claims modifications and changes can be made to the embodiments of the invention without departing from the scope of this invention defined in the following claims.

I claim:

1. A method for registering user interaction with a dynamic tactile interface comprising a tactile layer and a substrate, the tactile layer defining a tactile surface, a deformable region, and a peripheral region adjacent the deformable region and coupled to the substrate opposite the tactile surface, the deformable region cooperating with the substrate to form a variable volume filled with a mass of fluid, the method comprising:
at a sensor coupled to the substrate, detecting a first contact of an object at a first location on the tactile surface;
detecting a transition of the object along the tactile surface from the first location at a first time to a second location adjacent the deformable region at a second time;
substantially at the first time, detecting a first pressure of the mass of fluid at a remote pressure sensor fluidly coupled to the variable volume;
substantially at the second time, detecting a second pressure of the mass of fluid at the remote pressure sensor;
in response to a pressure difference between the first pressure and the second pressure, interpreting the transition as a gesture; and
in response to the gesture, executing a command corresponding to the gesture at a processor.
